(19) United States
(12) Patent Application Publication
(10) Pub. No.: US 2013/0337122 A1
(43) Pub. Date: Dec. 19, 2013

(54) NATURAL AND CHEWY FRUIT / VEGETABLE DEHYDRATED DICES OR PIECES

(71) Applicants: Hugues Falquerho, Betton (FR); Cecile Pussat, Le Rheu (FR); Eric Vouland, Sarzeau (FR)

(72) Inventors: Hugues Falquerho, Betton (FR); Cecile Pussat, Le Rheu (FR); Eric Vouland, Sarzeau (FR)

(21) Appl. No.: 14/002,867

(22) PCT Filed: Mar. 2, 2012
(86) PCT No.: PCT/EP2012/053672

§ 371 Date: Sep. 3, 2013

Related U.S. Application Data
(60) Provisional application No. 61/448,850, filed on Mar. 3, 2011.
(60) Provisional application No. 61/510,757, filed on Jul. 22, 2011.

(51) Int. Cl. A23L 1/29

(52) U.S. Cl. CPC A23L 1/296
USPC 426/250; 426/465; 426/472; 426/302; 426/456; 426/392; 426/455; 426/640

(57) ABSTRACT

The present invention concerns a new method for dehydrating natural fruit and/or vegetable products in order to modify their textural properties, so as to obtain chewy and non-sticky dices or pieces intended to be used by people having (or suffering from) difficult chewing, for example in sweet food, in dried savoury food, in baby food, hospital food, food for seniors and/or clinical nutrition for people with medical conditions.

### FIELD OF THE INVENTION

The present invention concerns a new method for dehydrating natural fruit and/or vegetable products in order to modify their textural properties, so as to obtain chewy and non-sticky dices or pieces intended to be used in food products, in particular by people having (or suffering from) difficult chewing, for example in baby food, hospital food, food for seniors and/or clinical nutrition for people with medical conditions.

### DESCRIPTION OF THE RELATED ART

The purpose of the present invention was to obtain biological products having a particular springiness, so as to be attractive and easily chewed by young and adult people, in particular those having (or suffering from) difficult chewing, for example babies, old people, hospitalized people or people suffering from medical conditions/recovering from accidents. Such products would thus be useful in particular in baby food, especially for babies aging 12-36 months, or in special meals dedicated to people older than 70 years, or to clinical nutrition including hospital food or in food designed for people with special dietary requirements.

Baby food is any food, other than breast milk or infant formula, which is made specifically for infants, roughly between the ages of four months to three years. The food comes in multiple varieties and tastes. Because infants lack efficient teeth for chewing, baby foods are to be designed for ease of eating; they must be either soft, liquid paste or easily chewed. Also, the high quality and safety standards of baby food ingredients represent significant barriers to the development of new raw material sourcing.

When old people (aging for example more than 70 years) undergo teeth loss, they are progressively suffering from chewing difficulties. As for the baby food, their meals are thus to be soft and easily chewed. They have also to be tasty and attractive. The same requirements are to be followed in clinical nutrition, because sick or hospitalized people are often too weak for eating normal meals.

Thus, there is a need of biological products in dices or pieces matching the quality and safety standards of baby food or clinical nutrition ingredients, being long-lasting storable and easily chewable for people undergoing difficult chewing, such as babies, old and/or sick or hospitalized people, or in all kind of food where optimal springiness is required, such as breakfast cereals, snack bars, or cereal bars. Such products would ideally have the same taste than the initial fresh products.

Springiness of food ingredients is a great part of the organoleptic properties of food products. The present Inventors have identified that food ingredients whose springiness is comprised between 30% and 40% are very attractive for adults and babies. There are however few dehydrating processes which enables to obtain ingredients having such springiness once they are rehydrated. There was therefore a need of identifying a dehydrating process enabling to reproducibly obtain dehydrated fruit or vegetables ingredients having i) the desired springiness (once rehydrated), ii) the same taste than the initial fresh products.

Dehydrating by drying is a method of food preservation that works by removing water from the food, which inhibits the growth of microorganisms and hinders quality decay. Drying food using sun and wind to prevent spoilage has been practiced since ancient times. Water is usually removed by evaporation (air drying, sun drying, smoking or wind drying). Fruits change character completely when dried: the plum becomes a prune, the grape a raisin; figs and dates are also transformed in new, different products, having their own organoleptics properties. In particular, natural color and taste are often completely modified through the air drying process.

Other methods for dehydrating biological products so as to enhance their storage capacity are well known. In particular dehydration processes comprising i) heating of the products and ii) pressure changes have been proposed.

Freeze-drying (also known as lyophilisation, lyophilization or cryodesiccation) is a dehydration process typically used to preserve a perishable material or make the material more convenient for transport. Freeze-drying works by freezing the material and then reducing the surrounding pressure and adding enough heat to allow the frozen water in the material to sublime directly from the solid phase to the gas phase. If a freeze-dried substance is sealed to prevent the reabsorption of moisture, the substance may be stored at room temperature without refrigeration, and be protected against spoilage for many years. Preservation is possible because the greatly reduced water content inhibits the action of microorganisms and enzymes that would normally spoil or degrade the substance. Freeze-drying causes less damage to the substance than other dehydration methods using higher temperatures. Freeze-drying does not usually cause shrinkage or toughening of the material being dried. However, flavors and nutritional content of the biological products are generally affected by the freeze-drying process. Also, loss of other volatile compounds such as acetic acid (vinegar) and alcohols can yield undesirable results. Importantly, this technology does not modify the texture of the food product, and the resulting pieces are therefore not adapted to the specific needs of the babies, seniors or sick or hospitalized people. Additionally, freeze drying technology is not appropriate to achieve the microbiological level required for baby food products, clinical nutrition products and/or senior food products.

To remedy these drawbacks, European patent EP 0435302 describes a process for totally or partially dehydrating biological products such as vegetables or fruits, a dehydration device and the corresponding products, the process comprising the steps of de-pressurizing the enclosure in which the biological products are deposited, heating the wall of the enclosure, introducing water vapour it, again de-pressurizing, heating the plates, and re-pressurizing the enclosure to the pressure of the atmosphere. This process enables to ensure long lasting storage of the biological products, the thereby dehydrated products conserving consistency, taste and colour of the initial biological products). Again, this process is not appropriate to modify the texture of the resulting products in a proper way for complying with baby, senior or sick or hospitalized people needs.

On the other hand, U.S. Pat. No. 5,855,941 discloses a method for changing the texture of phytogenic materials comprising a sharp pressure-reduction step, following a heating phase and pressurization of the products. This sharp pressure-reduction provokes rapid vaporization of the water that is contained in the plant-based products. One thus obtains a slightly spongy structure of the phytogenic material, which is due to the presence of micro-cavities that promote the recapture of subsequent moisture. This process is used to modify the texture of the biological products, in order to prepare products having a slightly spongy structure, which is due to the presence of micro-cavities that promote the recapture of subsequent moisture. The inventors did not disclose experimental parameters enabling to obtain food pieces having the required texture for use in baby food, clinical nutrition and/or senior food.

Also, U.S. Pat. No. 6,551,644 discloses a process for changing the structure and/or the texture of alimentary compounds comprising a step of heating the products to be treated followed by a cooling step based on a pressure drop to vacuum. This process is characterised by the fact that the degree of expansion of the products during the process is lower than 1.5. However, the thus obtained pieces of food are not adapted for use in baby food, clinical nutrition and/or senior food in so far as they are not easily chewed.

Yet, the present Inventors have surprisingly found that fruit and vegetable dices or pieces obtained through the method of the invention fulfill all the above-mentioned requirements as far as springiness is concerned, and can be used in baby or other foods where optimal springiness is required, such as breakfast cereals, snack bars, or cereal bars. The 50° C. water rehydrated dices or pieces of the invention are non-sticky, have good sensory properties (even with no added sugar), and a bright natural color. They have a soft and chewy texture, a springiness comprised between 30 and 40%. They can for example be safely used in clinical nutrition (including hospital food), baby food or senior food (microbial contaminant are destroyed during the fabrication process), providing attractive solutions to the market in the field of these foods. They can advantageously be used in all kind of food where optimal springiness is required, such as breakfast cereals, snack bars, or cereal bars.

Such biological products would be for example useful tools for the babies to learn the taste of many fruits and/or vegetables, and for educating them to chewing.

Alternatively, they could serve as easy-to-use, tasty and easily chewable meal for sick, old or sick or hospitalized people.

### FIGURE LEGENDS

FIG. 1 discloses a schematic view of the process of the invention.

FIG. 2 discloses the weight gain, during the rehydration process with hot water at 50° C., of fruit pieces that were dehydrated by different processes: A) Apple dices obtained with the process of the invention (“Apple new pieces”), conventional air drying (“Apple air dried 2”), DIC process (“Apple DIC standard”) or by air drying without DIC process (“Apple air dried 1”, which is currently on the market). B) Strawberry dices obtained with freeze dried fruits or with the process of the invention (“new pieces”). C) Mango dices obtained with the process of the invention (“new pieces”) or by freeze drying. D) Carrot dices obtained with the process of the invention (“new pieces”) or by air drying.

FIG. 3 discloses the springiness of A) apple pieces that were dehydrated by different processes: the process of the invention (“Apple new pieces”), conventional air drying (“Apple air dried 2”), DIC process (“Apple DIC standard”) or by air drying without DIC process (“Apple air dried 1”, which is currently on the market) after the rehydration process with hot water at 50° C. B) springiness of carrot dices that were dehydrated by different processes: the process of the invention (“new pieces”), DIC process (“Apple DIC standard”) or by air drying without DIC process (“air dried”) or by puffing, after the rehydration process with hot water at 50° C.

FIG. 4 discloses a graph showing how to calculate the F1 and F2 values for estimating springiness of a product.

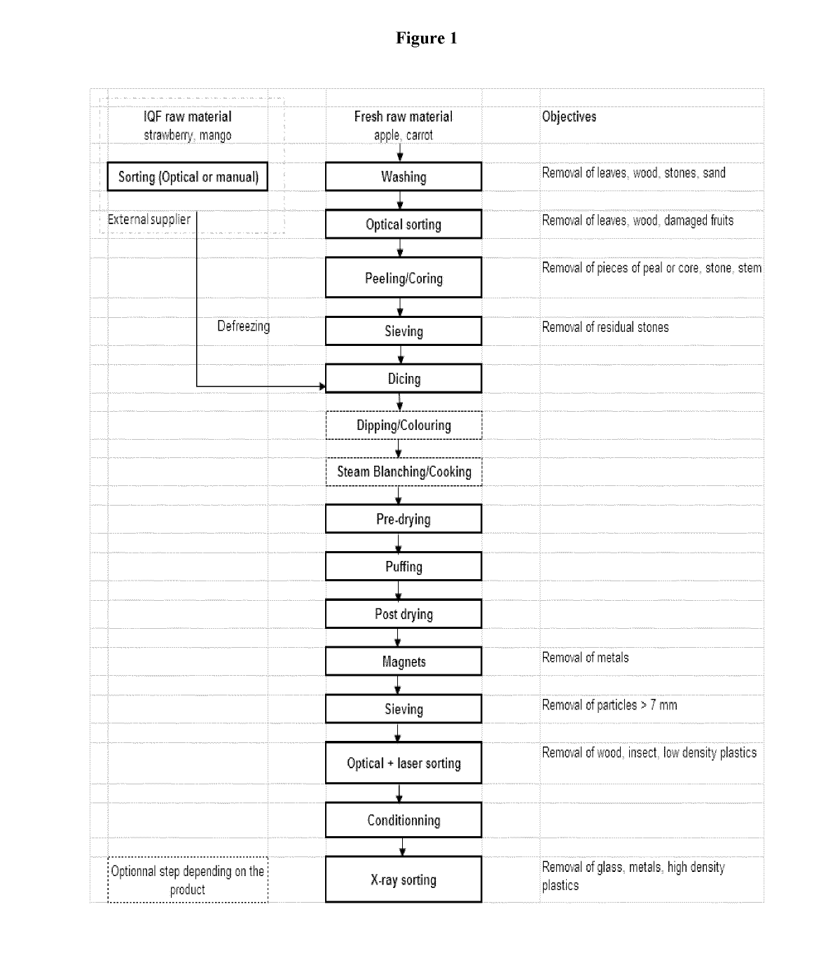

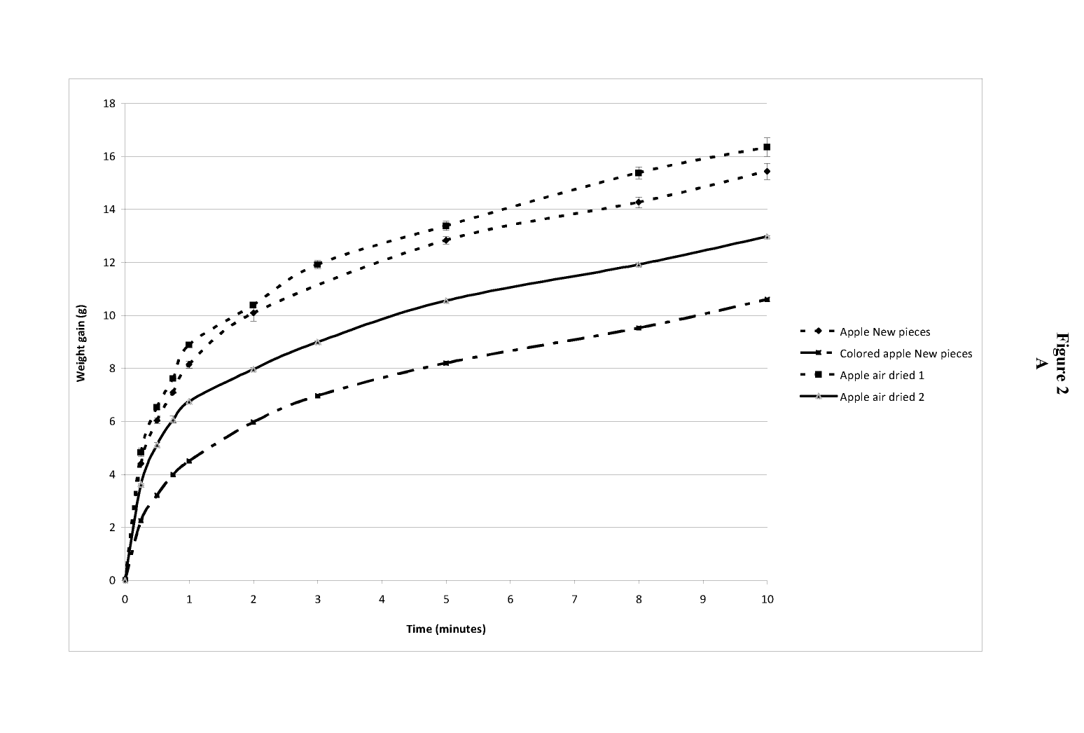

### DETAILED DESCRIPTION OF THE INVENTION

In a first aspect, the present invention discloses a method for obtaining dehydrated dices or pieces of fruits or vegetables comprising the following steps:
a) Providing dices or pieces of fruits or vegetables,
b) Pre-drying said dices or pieces of fruits or vegetables,
c) Dehydrating the pre-dried dices or pieces of fruits or vegetables obtained in step b) in an instant controlled pressure drop (DIC) reactor, and
d) Post-drying of the thus dehydrated dices or pieces of fruits or vegetables.

These dehydrated dices or pieces of fruits or vegetables are hereafter called “the dehydrated products of the invention”. These dehydrated products are poorly hygroscopic and are shelf-stable for at least 12 months. These products are dedicated to be put in contact with hot liquid so as to obtain the “rehydrated products of the invention”, which will be ultimately eaten. These rehydrated products have the intended soft texture (so as to be easily chewed) and have very attractive organoleptic properties (taste and color).

In a preferred embodiment of the invention, the rehydrated products of the invention are obtained by contacting them with 50° C. hot water during 1 minute. These “one minute in 50° C. water rehydrated products” have a springiness comprised between 30% and 40%., which corresponds to the optimal value (the product should be enough elastic to chew but not too much for babies, senior or sick or hospitalized people).

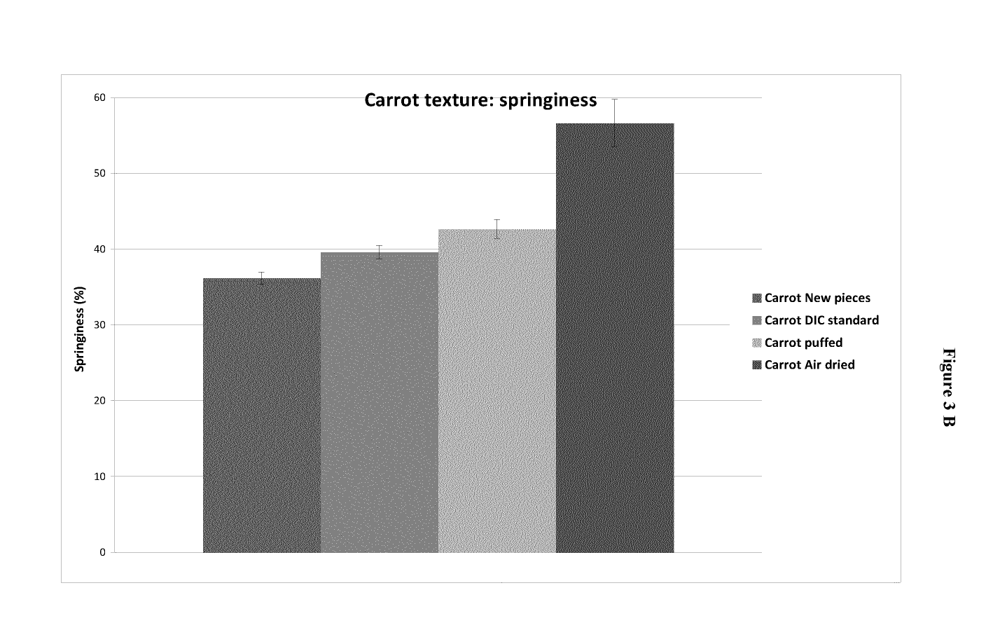

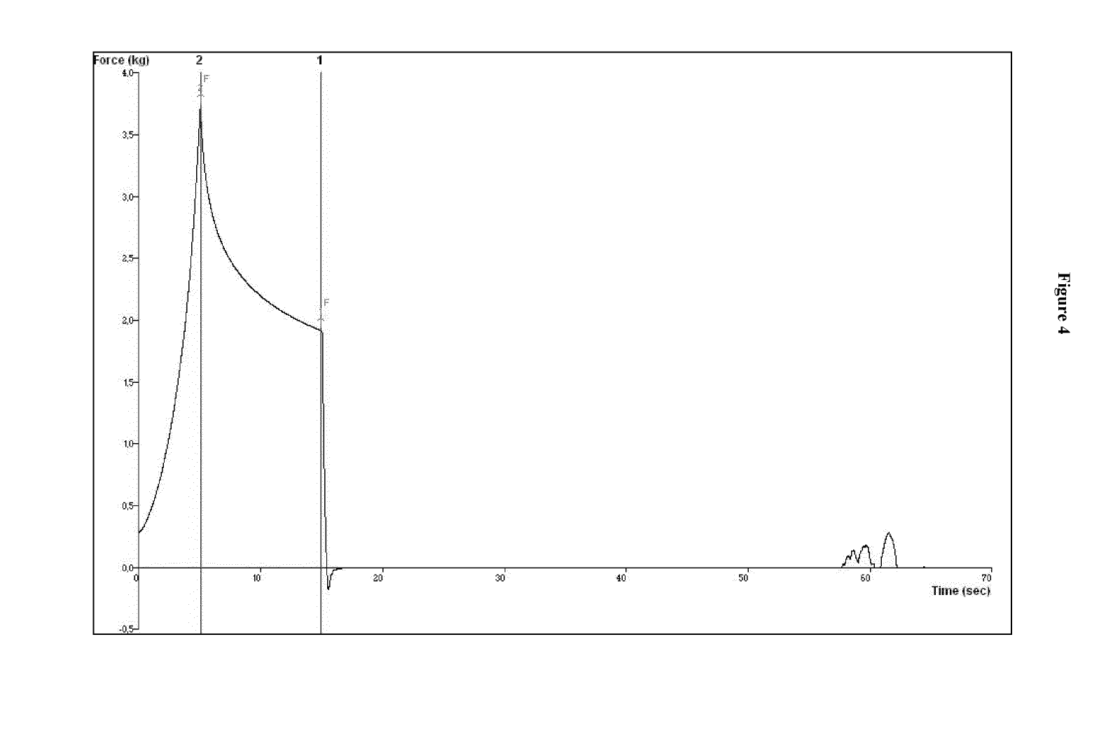

The “springiness” corresponds to the shape recovery capacity of products, after applying a compression. It can be measured for example by applying a high compression force onto products, during a given time, leading to a 50% reduction of height of the products. At this stage, the maximal force applied F2 is measured. Then the compression is maintained during 15 seconds to check the ability of the product to recover its shape. This ability is expressed by the force F1 measured after 15 seconds of compression (see FIG. 4). The springiness is calculated with the following ratio: 100*(F1/F2) where F2 is the maximal force and F1 is the force measured after 15 seconds. Higher is the ratio, higher is the springiness of the product. Springiness can be measured by different systems well known from the person skilled in the art. For example, springiness can be measured with the texture analyzer TA-XT+ (Stable micro system) having a 5 cm diameter cylinder probe.

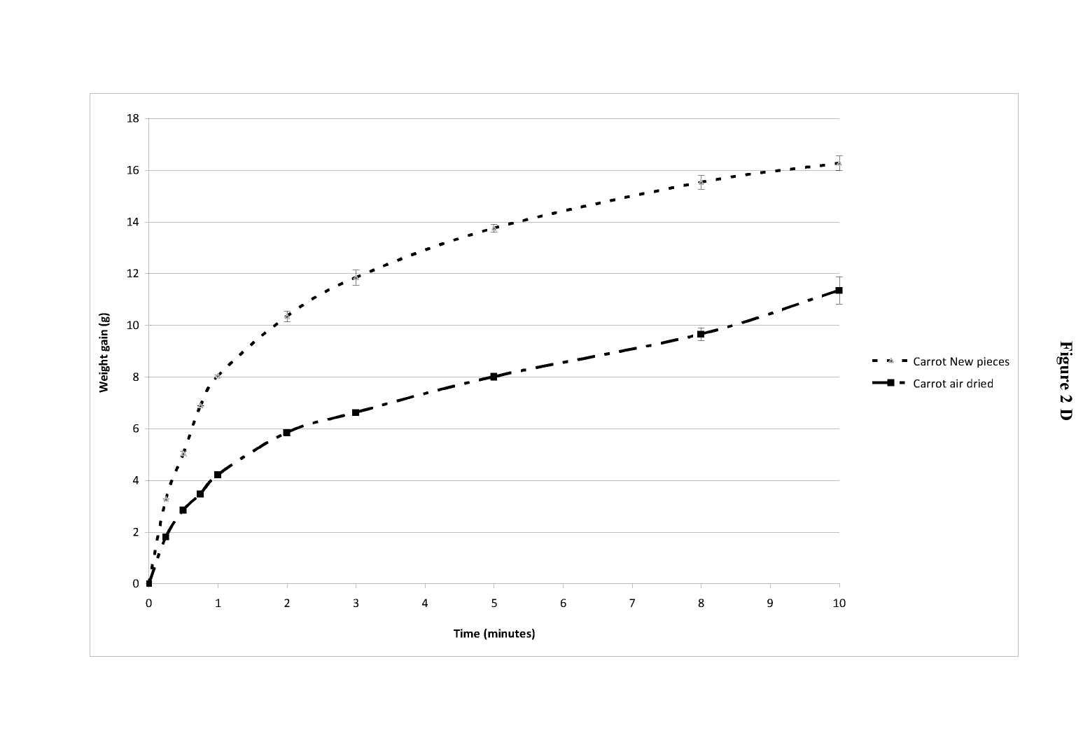

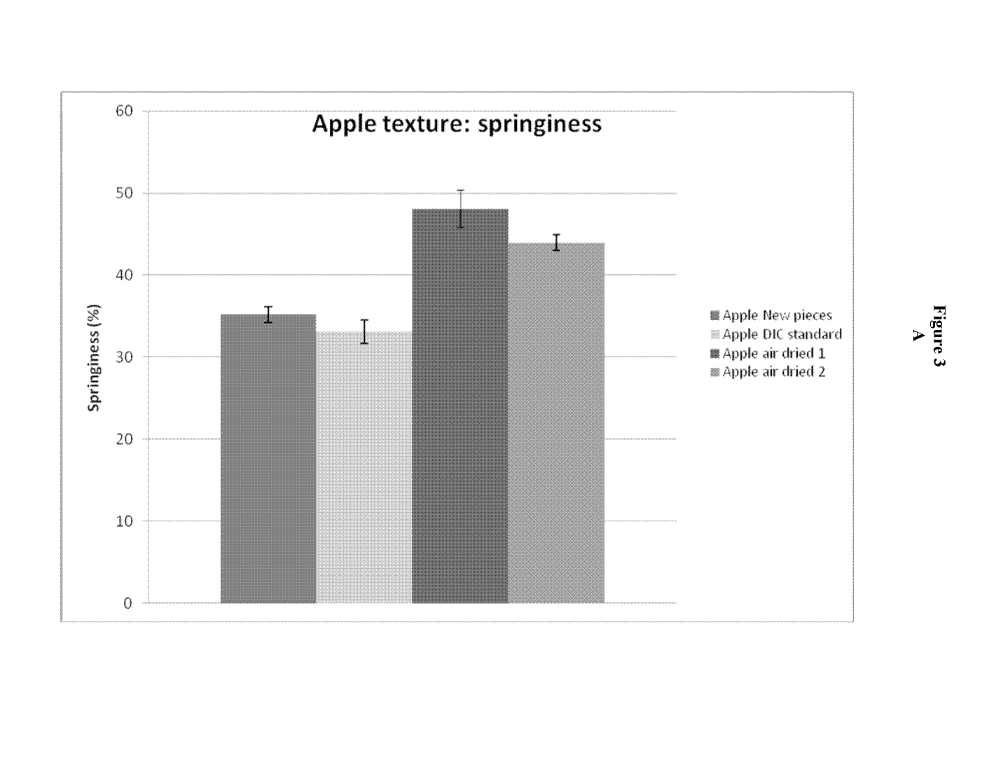

It has been measured that the rehydrated apple products of the invention have a springiness comprised between 30% and 40%, which corresponds to the ideal springiness for being easily chewed. These apple products have a significant lesser springiness than the products obtained with conventional air drying or the one currently available on the market (see FIG. 3A).

Also, it has been measured that the rehydrated carrot products of the invention have a springiness comprised between 30 and 40%, which corresponds to the ideal springiness for being easily chewed. These carrot products have a significant lesser springiness than the products obtained with conventional air drying or the one currently available on the market (see FIG. 3B).

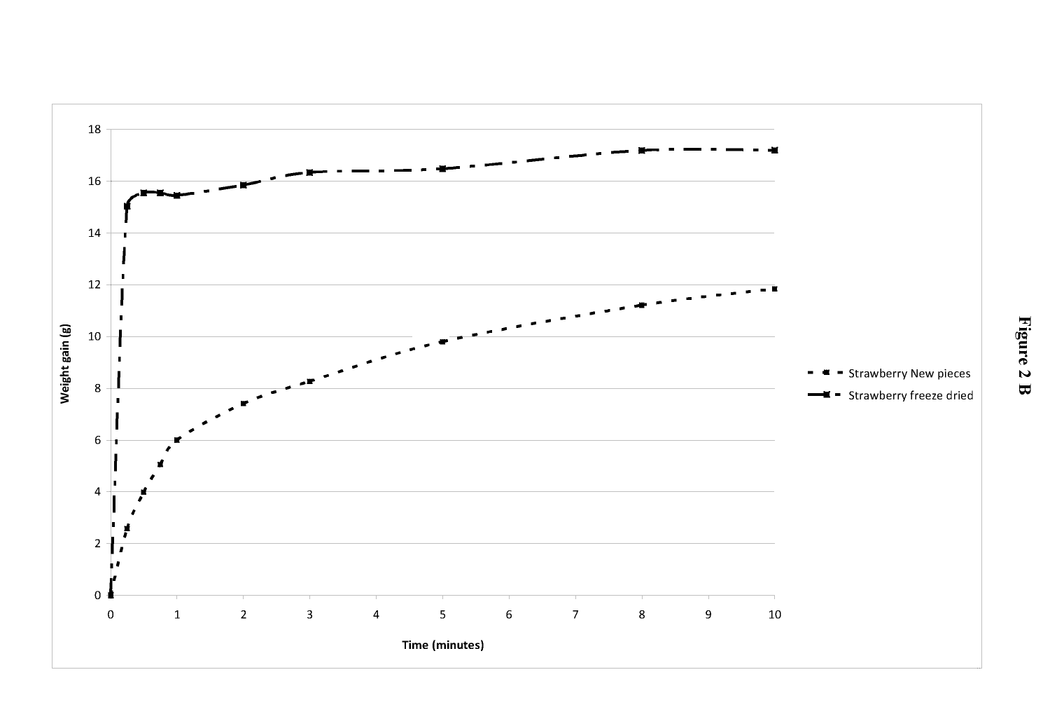

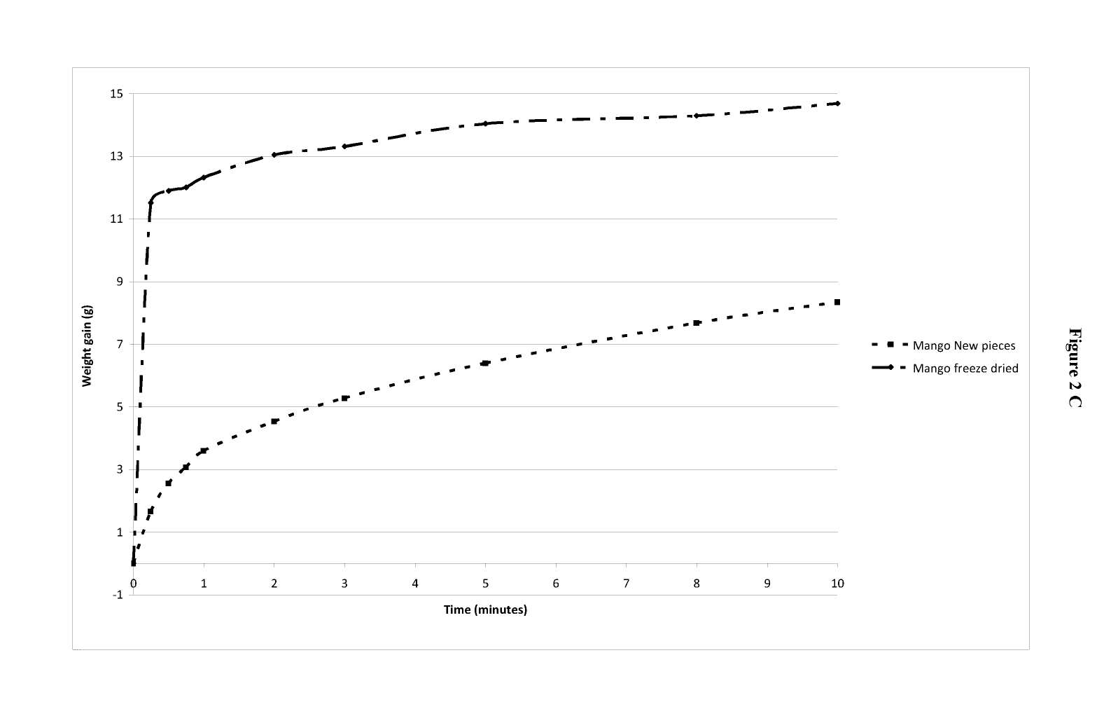

The dehydrated products of the invention have a rehydration speed in 50° C. water which varies depending on the fruit or vegetable which is considered. For example, the rehydration speed of the apple dices of the invention is comprised between 2 and 5 grams (g) of water/gram of apple dices, preferably between 3 and 4 grams of water/gram of apple dices after ten minutes in contact with 50° C. water. The rehydration speed of the strawberry dices of the invention is comprised between 1 and 4 grams of water/gram of strawberry dices, preferably between 2 and 3 grams of water/gram of strawberry dices after ten minutes in contact with 50° C. water. The rehydration speed of the mango dices of the invention is comprised between 0.5 and 3 grams of water/gram of mango dices, preferably between 1 and 2 grams of water/gram of mango dices after ten minutes in contact with 50° C. water. The rehydration speed of the carrot dices of the invention is comprised between 2 and 5 grams of water/gram of carrot dices, preferably between 3 and 4 grams of water/gram of carrot dices after ten minutes in contact with 50° C. water (see FIGS. 2A, 2B, 2C and 2D).

These rehydration speeds are surprisingly drastically different than the one measured for products obtained through the processes of the prior art (see FIGS. 2A, 2B, 2C and 2D).

Any kind of fruits can be used in the method of the invention, including: apples, pears, peaches, strawberries, raspberries, blackberries, redcurrants, blackcurrants, blueberries, cherries, mangos, bananas, oranges, lemons, grapefruits, pineapples, apricots, papayas, plums, prunes, grapes, cranberries.

Also, any kind of vegetables can be used, including: carrots, green peas, green beans, broccoli, spinach, pumpkins, maize, tomato, sweet potatoes, onions, potatoes, celery, leeks, beetroots, and turnips.

The method of the invention can be applied to different fruits or vegetables concomitantly, if need be.

As used in the present invention, the term “dices or pieces” designate pieces of fruits or vegetables that have rather a regular form, such as a cubic, or an irregular form. The dices or pieces of the invention should have a size enabling easy chewing by babies, seniors or sick or hospitalized people while preventing trouble swallowing. When cubic, the dices or pieces preferably have a size of at least 3×3×3 mm to at most 15×15×15 mm after the process. When irregular, each side of the pieces has a size of at least 3 mm to at most 15 mm. In a preferred embodiment, the dices or pieces of the invention are cubic.

Both fresh and Individually Quick Frozen (IQF) raw material can be used and provided in step a) of the method of the invention.

IQF fruit or vegetable are obtained through a highly controlled process comprising a washing step i), a sorting step ii), and, if needed, a peeling and/or a coring step (step iii), before being frozen. Sometimes, the fruits or vegetables are also diced (step iv) before undergoing freezing. In case IQF raw material is actually used, it can be therefore useless to perform steps i) to iii) of the method of the present invention, which have been already performed.

The method of the present invention can use frozen or IQF fruit or vegetable dices or pieces insofar as their size is bigger than the above-mentioned sizes (3×3×3 mm for cubic dices or pieces).

In case fresh raw fruits or vegetables are used, the dices or pieces used in the method of the invention can be obtained by a method comprising:
i) If required, the washing of said fruits or vegetables, so as to remove potential dust and sand,
ii) The optical sorting of said fruits or vegetables, so as to remove damaged fruits or vegetables, wood, leaves and/or stones,
iii) If required, the removal of peel, core, seeds, and stem of said fruits or vegetables, and
iv) The dicing of said fruits or vegetables.

In step i), fresh raw material are washed so as to remove potential dust and sand, for example with water.

Step ii) of optical sorting can be performed by using manually or automatically sorting, so as to remove the damaged fruits/vegetables, leaves, wood, and/or stones. Optical Sorting is a process of visually sorting a product though the use of photodetectors (light sensors), camera, or the human eye. In its simplest operation, a machine will simply see how much light is reflected off the object using a simple photodetector (such as a photoresistor) and accept or reject the item depending on how reflective it is (light or dark). More sophisticated systems use image processing to discriminate the colors of the object, often via a controlled spectrum of light, even beyond the visible spectrum into the IR and UV range. Shape detection is an evolving ability. The common method of removal is jets of compressed air, but others exist. The term “optical sorting” therefore includes manual seeing and manipulating processes, metal detection, laser sorting and X-ray sorting.

The removal of peel (step iii) is required for example for mangos, pears, apples, bananas, carrots, etc.

The removal of cores or seeds is required for example for mangos, dates, apricots, peaches, cherries, etc.

The fruits/vegetables are further diced (step iv) into small and almost homogenous dices or pieces having the preferred size of at least 3×3×3 mm to at most 15×15×15 mm. When irregular, each side of the pieces preferably has a size of at least 3 mm to at most 15 mm. In a preferred embodiment, the cut dices or pieces of the invention are of cubic form.

IQF or frozen raw materials that are not already diced can be defrosted to −10° C. before achieving the dicing step iv). Then dices or pieces are defrosted up to 5° C. before achieving step b) of pre-drying.

In case frozen or IQF raw material has undergone dicing before freezing, it is no use to perform step iv) of dicing, unless the dices or pieces are bigger than 15×15×15 mm. In case they have been frozen in an appropriate size, the dices or pieces can be defrosted up to 5° C. before achieving step b) of the method of the invention.

In an embodiment, the method of the invention comprises a coloring step of the method of the invention, preferably by dipping dices or pieces in or by spraying dices or pieces with a natural colouring foodstuff, more preferably with a fruit or vegetable juice concentrate such as a blackcurrant juice, a tomato juice, a carrot juice, a beetroot juice, a strawberry juice, and other redfruit juices. This colouring step can be performed before or after the pre-drying step b). Advantageously, it is performed before the pre-drying step b).

More preferably, naturally lightly coloured fruits or vegetables, such as apples, potatoes, bananas, pears, and turnips undergo such a colouring step. In example, apple dices or pieces with blackcurrant juice have been obtained. This colouring step is helpful to improve the visual impact of the dices or pieces into the final food products, in order to detect them easily. Therefore, the time of dipping (or spraying) in (or with) the colouring solution depends on the targeted colour to obtain.

In another embodiment, the dices or pieces of fruits or vegetables are dipped in or sprayed with an aqueous solution comprising an anti-sticking agent, an anti-oxidating or anti-browning agent, and/or an agent impairing the dices or pieces to get rancid in order to ensure longer shelf-life, less agglomerating and thus ensure sustainable supply. This dipping or spraying step can be performed before or after the pre-drying step b). Advantageously, it is performed before the pre-drying step b).

As a matter of fact, some fruits and vegetables get easily rancid or oxidized, namely carrots, apples, strawberries or mangos, etc. Other agglomerate very easily such as red fruits.

For example, the dices or pieces might be dipped in or sprayed with an aqueous solution containing an antioxidant such as citric acid or ascorbic acid or lemon juice (to prevent oxidation and browning), tocopherol or ascorbyl palmitate (to prevent the dices or pieces to get rancid), medium chain triglycerides (MCT) or other vegetal oils or starch or pectin or citrus fibre or an emulgator based on lecithin (to prevent the dices or pieces from sticking on the belt dryer or agglomerating together).

In particular, 0.5 to 2% of citric acid E330, 0.2 to 2% of ascorbic acid E300, 1% to 7% of medium chain triglycerides, 1% to 3% of emulgator based on lecithin E322, 1% to 10% of coloring foodstuffs (fruits or vegetable juice concentrates) can be used. Typically, the dipping solution contains 1.0% of citric acid, 0.5% of ascorbic acid, 5% of medium chain triglycerides or 5% of vegetal oil, and 2.5% of emulgator based on lecithin. Ascorbyl palmitate E304 can be used at a level of 0.1 g/kg individually or in combination with tocopherols. Mixed tocopherol E306 and alpha tocopherol E307 can be used individually or in combination with ascorbyl palmitate at 0.1 g/kg according to the European regulations.

As an example, apple dices or pieces can be dipped in or sprayed with a solution containing citric acid and/or ascorbic acid so as to prevent their browning, and, against agglomerating, with MCT or vegetal oil and/or lecithin. Strawberry or mango dices or pieces can be dipped in or sprayed with a solution containing citric acid and/or ascorbic acid so as to prevent their browning, and/or MCT or vegetal oil and/or lecithin for impairing their agglomeration. Carrot dices or pieces can be dipped in or sprayed with a solution containing ascorbyl palmitate and/or tocopherol to prevent them of getting oxidized.

In another embodiment, the method of the invention comprises a blanching or a cooking step before the pre-drying step b). Such step is used depending on products and texture target, so as to inactivate enzymes and/or to soften texture. It is for example required for firm vegetables such as carrots, celery, turnips, beetroots, potatoes, pumpkins, green peas, green beans, maize, onions or sweet potatoes.

Typically, this cooking step is performed at a temperature comprised between 80° C. and 130° C. during 20 minutes to 40 minutes into a water or steam cooker, for firm vegetables such as carrots, celeriac, turnips, beetroots, potatoes or sweet potatoes.

Typically, this cooking step can be performed at a temperature comprised between 80° C. and 130° C. during 5 minutes to 15 minutes into a water or steam cooker, for less firm vegetables such as pumpkins, green peas, green beans, maize or onions.

Typically, this cooking step can be performed at a temperature comprised between 80° C. and 130° C. during 5 seconds to 5 minutes into a water or steam cooker, for soft vegetables such as spinach, broccoli, celery, leeks or tomatoes.

The prepared dices or pieces then enter a pre-drying step b). Such pre-drying step can be achieved for example on a fluid bed, in a continuous chamber or under vacuum. This step is preferably conducted at a temperature that is comprised between 30° C. and 120° C., preferably between 70 to 90° C., during 30 minutes to 6 hours, preferably between 30 minutes and 2 hours. Advantageously, this pre-drying step preserves the colour, the taste and the form of the raw fruit or vegetable material which is used.

Dehydrating step c) of the method of the invention is a DIC step (Instant Controlled pressure drop technology), comprising a vacuum puffing step. This step consists in submitting the pre-dried fruit/vegetable dices or pieces to a short time heat treatment followed by a sudden drop pressure towards vacuum. The DIC process has been widely described in U.S. Pat. No. 5,855,941 and in U.S. Pat. No. 6,551,644 which are incorporated herein by reference.

The prepared dices or pieces are thus introduced into a DIC reactor. Such reactor can be furnished for example by ABCAR DIC process SAS.

In a preferred embodiment, the DIC process used in step c) comprises, in the DIC reactor:
i) A short-time heat treatment at a temperature of 100° C. to 170° C. a pressure of between 1 to 8 bars, during 5 seconds to 1 minute,
ii) A rapid drop pressure toward vacuum, lasting less than 1 second.
iii) Maintenance of the vacuum, lasting less than 10 seconds
iv) Re-pressurising the reactor up to the atmosphere pressure.

This step allows giving a porous texture and increasing the rehydration speed, softening the texture and destroying bacteria. This step, combined with the other steps of the process, is crucial for obtaining a product with instant rehydration characteristics and soft/chewy texture as required. Moreover, it preserves the color, the taste and the form of the raw fruit or vegetable material which is used.

In a more preferred embodiment, the heat treatment of step i) lasts between 5 seconds and 30 seconds at a temperature which is comprised between 100° C. and 160° C., at a pressure comprised between 1 and 6 bars.

In a preferred embodiment of the invention, after the dehydrating step c), the content in bacteria in the dices or pieces is less than 1000 u/g, more preferably less than 500 u/g and absence of Enterobacteriaceae in 1 g

To complete the process of the invention, a post-drying step d) is moreover required for achieving a final moisture and water activity at a low level. The aim of this step is to decrease the moisture to be less than 5%, and to reach an optimum water activity (Aw) comprised between 0.2 and 0.3.

This post-drying step d) is preferably an air drying, and occurs at a temperature comprised between 50° C. and 100° C., which is maintained during 10 minutes to 120 minutes. More preferably, the temperature of this step is comprised between 60° C. and 80° C. and is maintained during between 45 minutes and 90 minutes. Advantageously, this pre-drying step preserves the colour, the taste and the form of the raw fruit or vegetable material which is used.

As every effort must be done to prevent all foreign bodies in raw materials intended for Infant Nutrition products, a further step of sorting may be present in order to remove foreign bodies from the obtained dices or pieces. Most safety issues concern particles having a mean diameter above 2 mm. Hence the prevention and detection means in place should at least achieve the elimination of such particles which are the more critical.

This step of sorting can be conducted either automatically or manually, for example by optical sorting, as defined above.

Thus, in a particular embodiment, the method of the present invention further comprises a step of optical sorting of foreign bodies from the dehydrated fruit or vegetable dices or pieces, preferably performed by laser sorting, X-ray sorting, and/or metal detection.

Eventually a conditioning step under modified atmosphere might also be introduced so as to prevent the thus obtained dehydrated fruit/vegetables dices or pieces from getting rancid. Some products get easily rancid, namely carrots, pumpkins, sweet potatoes, etc.

In a second aspect, the present invention targets dehydrated fruit or vegetable dices or pieces obtainable by the method of the invention.

The dehydrated apple dices or pieces obtained by the process of the invention have a springiness comprised between 30% and 40%, after being rehydrated during one minute in 50° C. water.

Rehydration speed in 50° C. water varies depending on the fruit or vegetable which is considered. For example, the rehydration speed of the apple dices of the invention is comprised between 2 and 5 grams (g) of water/gram of apple dices, preferably between 3 and 4 grams of water/gram of apple dices after ten minutes in contact with 50° C. water. The rehydration speed of the strawberry dices of the invention is comprised between 1 and 4 grams of water/gram of strawberry dices, preferably between 2 and 3 grams of water/gram of strawberry dices after ten minutes in contact with 50° C. water. The rehydration speed of the mango dices of the invention is comprised between 0.5 and 3 grams of water/gram of mango dices, preferably between 1 and 2 grams of water/gram of mango dices after ten minutes in contact with 50° C. water. The rehydration speed of the carrot dices of the invention is comprised between 2 and 5 grams of water/gram of carrot dices, preferably between 3 and 4 grams of water/gram of carrot dices after ten minutes in contact with 50° C. water.

In a third aspect, the present invention also targets a method for obtaining non-sticky soft rehydrated dices or pieces of fruits or vegetables comprising the following steps:
a) Providing dices or pieces of fruits or vegetables,
b) Pre-drying said dices or pieces of fruits or vegetables,
c) Dehydrating the pre-dried dices or pieces of fruits or vegetables obtained in step b) in an instant controlled pressure drop (DIC) reactor,
d) Post-drying of the thus dehydrated dices or pieces of fruits or vegetables,
e) Optionally, conditioning or packaging the dehydrated dices or pieces obtained in step d),
f) Rehydrating the dehydrated dices or pieces obtained in step d) or e).

Typically, such rehydrating step f) can be performed by adding hot liquid having a temperature comprised between about 40° C. and 70° C., and being preferably about 50° C. onto the dices or pieces, during a time of at least about 30 seconds, preferably at least about 1 minute. As shown on FIG. 2, the rehydration is optimal one minute after the contact with 50° C. water. However, it is of course possible to further maintain the rehydration, for example up to 5 minutes, until the rehydrated product is eaten.

In a particular embodiment, the rehydrated dices or pieces obtained by the process of the invention have a springiness comprised between 30% and 40% once rehydrated in 50° C. water during 1 minute.

Preferably, said liquid is milk or water.

The thus rehydrated pieces or dices are well adapted for young and adult people, especially those undergoing chewing difficulties, such as babies aging between 12 and 36 months, or old or sick or hospitalized people.

In a fourth aspect, the present invention targets the use of the dehydrated or rehydrated fruit or vegetable dices or pieces obtained by the method of the invention in sweet food products or in dried products, in particular in a baby food, a senior food or in clinical nutrition including hospital food.

Without being exhaustive, said sweet food products can be for example breakfast cereals, snack bars, cereal bars, dairy products, ice cream, bakery or biscuits.

Dried products can be for example dried soups, dried sauces, dried ready meals, instant noodles, salad dressing and toppings, savoury baked goods, or savoury snacks.

In a fifth aspect, the present invention targets a food product, and in particular a baby food, a clinical nutrition (including hospital food) and/or a senior food, or a cereal bar, a breakfast cereal or a snack bar, comprising the rehydrated fruit or vegetable dices obtained by the method of the invention.

The “baby food” that is targeted in the present invention is dedicated to very young children aging between 4 months and 3 years.

The clinical nutrition (including “hospital food”) that is targeted in the present invention is dedicated to be given to sick people at home and/or hospitalized patients having difficulties to chew.

The “senior food” that is targeted in the present invention is dedicated to be given to senior people that are people aging more than 70 years, preferably more than 80 years.

### EXAMPLES

### 1. Material and Methods

Four products have been developed and approved as following all the requirements concerning taste, texture and color:

1.1. Apple Dices or Pieces

DIC is, by definition, an abrupt pressure drop toward vacuum following a high temperature short term treatment (HTST) by steam injection. It can be considered as a critical control point for all the products.

Parameters to be used for obtaining apple dices or pieces of the invention:

| | | Temperature | Absolute | Time |
|---|---|---|---|---|
| | To be done? | (° C.) | Pressure (bar) | (min or sec) |
| Blanching/ | No | Ø | Ø | Ø |
| cooking ? | | | | |
| Step e) pre- | Yes | 80 | Ø | 50 min |
| drying | | | | |
| Step f) DIC | Yes | 120 | 2 | 20 sec |
| Step g) Post- | yes | 65 | Ø | 90 min |
| drying | | | | |

1.2. Strawberry Dices or Pieces

Parameters to be used for strawberry dices or pieces:

| | | Temperature | Absolute | Time |
|---|---|---|---|---|
| | To be done? | (° C.) | Pressure (bar) | (min or sec) |
| Blanching/ | No | Ø | Ø | Ø |
| cooking ? | | | | |
| Step e) pre- | Yes | 80 | Ø | 50 min |
| drying | | | | |
| Step f) DIC | Yes | 133.5 | 3 | 10 sec |
| Step g) Post- | Yes | 65 | Ø | 90 min |
| drying | | | | |

1.3. Mango Dices or Pieces

Parameters to be used for mango dices or pieces:

| | | Temperature | Absolute | Time |
|---|---|---|---|---|
| | To be done? | (° C.) | Pressure (bar) | (min or sec) |
| Blanching/ | No | Ø | Ø | Ø |
| cooking ? | | | | |
| Step e) pre- | Yes | 80 | Ø | 45 min |
| drying | | | | |
| Step f) DIC | Yes | 152 | 5 | 20 sec |
| Step g) Post- | Yes | 65 | Ø | 90 min |
| drying | | | | |

1.4. Carrot Dices or Pieces

Parameters to be used for carrot dices or pieces:

| | | Temperature | Absolute | Time |
|---|---|---|---|---|
| | To be done? | (° C.) | Pressure (bar) | (min or sec) |
| Blanching/ | yes | 98 | Ø | 36 min |
| cooking ? | | | | |
| Step e) pre- | Yes | 80 | Ø | 45 min |
| drying | | | | |
| Step f) DIC | Yes | 144 | 4 | 20 sec |
| Step g) Post- | Yes | 65 | Ø | 90 min |
| drying | | | | |

For carrot, the cooking step is required.

1.5. Rehydration Comparisons

Non-optimized dices and competitor references using different technologies (hot air, freeze drying) were compared to new pieces of the invention. Measurements were carried out with 5 g of products. The samples are weight with a precision balance and dipped into hot water (50° C.). As soon as dices are in hot water, time is measured and takings are realized at the following times: 15s, 30s, 45s, 1, 2, 3, 4, 5, 8 and 10 minutes.

At each time, samples were drained with a sieve and weight. Water absorption was analyzed following the increase of weight of the 5 g sample during time by making the difference between the weigh at time t and the initial weigh. Results are shown on FIG. 2.

1.6. Texture Measurements

Texture of rehydrated dices was analyzed using a texture analyzer TA-XT+ (Stable micro system) with a 5 cm diameter cylinder probe. Comparison between the apple products of the invention, non-optimized dices (different DIC parameters) and concurrent references was done. For each measurement, ten dices were taken, put in application (1 minute in water at 50° C.), drained with a sieve and submitted to a uniaxial compression using the texture analyzer. As dices are not homogeneous, a pre-test was carried out: the module went down until it requires a 300 g force. When it reached this value, dices were homogenized and the test was launched.

To measure the springiness, sample was deformed with a 50% of the high compression. At this stage, the maximal force applied F2 is measured. Then the compression is maintained during 15 seconds to check the ability of the product to recover its shape. This ability is expressed by the force F1 measured after 15 seconds of compression (see FIG. 4). The springiness is calculated with the following ratio: 100*(F1/F2) where F2 is the maximal force and F1 is the force measured after 15 seconds.

Results are shown on FIG. 3.

1.7. Bacteriology

Bacteriologic experiments have been performed following the standard ISO processes as follows:
Total plate count: NF ISO 4833
Yeasts: NF V 08-036
Moulds: NF V 08-036
Enterobacteriaceae: NF ISO 21528
Salmonella: NF EN ISO 6579
Listeria monocytogenes: NF EN ISO 11290-1
Coagulase positive staphylococcus: NF EN ISO 6888

1.8. Method for Evaluating Shelf-Life Stability

Based on other dehydrated fruits and vegetables expertise (flakes and crunchies), the shelf life tests were elaborated by taking into account the specificities of the fruit dices or pieces. The stability at storage (caking, oxidation, color stability) and the preservation of the right texture in application have been studied.

The tests were generally performed at −18° C. or 0/4° C. for the control sample, 20° C. for room temperature, 30° C. for accelerated conditions.

The tests have started on two products:
Apple for caking, color stability and texture (7.5 months of ageing)
Carrot for oxidation (6 months of ageing).

1.9) Method for Evaluating Sticking Ability

Dices or pieces of uncolored apples were produced with or without anti-sticking agent (MCT or vegetal oil). 1 kg of dices or pieces is packaged in watertight pots stored at 0° C./+4° C., 20° C., or 30° C. during 3 months. The product moisture is 3.43% without the anti-sticking agent, and 2.43% with the anti-sticking agent. A weight was applied on the product in order to simulate the pressure at the bottom of the industrial bags.

1.10) Method for Evaluating Color Stability

Samples of uncoloured apple were packaged in glass pillboxes and stored at −18° C., 0/+4° C., 20° C. and 30° C. The evaluation was performed every 15 days by visual inspection. The samples got a mark between 1 (color of the control sample) and 10 (dark).

1.11) Method for Evaluating Oxidation Stability

Dices or pieces of carrot were produced with or without anti-oxidative agent (ascorbyl palmitate). They were packed into aluminium foil bags with or without nitrogen and stored at 0/+4° C. and 20° C. The tests were not performed at 30° C. because oxidation reactions are too fast at this temperature.

Every 15 days, samples were evaluated by an association of sensorial and analytical methods. Peroxide level and hexanal were measured. As intermediate products of oxidation, peroxide level characterizes the amplitude of the reactions. As one of the final products of oxidation, hexanal is a molecule representative of the level of components responsible of the oxidized note.

### 2. Results

The technology of the invention successfully delivers soft chewy fruits/vegetables with outstanding sensorial properties (taste, texture, color).

2.1. Rehydration Speed

The rehydration speeds between four different apple based-products have been compared:
“Apple Air dried 1”: air-dried apple dices from the market
“Apple Air dried 2”: apple dices dried with hot air (65° C., 5 hours)
“Apple DIC standard”: apple dices dried with a classical DIC process (3 bars, 20 seconds, 133.5° C., with pre-drying step (80° C., 55 nm) and post-drying step (65° C., 90 nm))
“Apple NEW pieces”: apple dices of the invention (DIC process: 2 bars, 20 seconds, with pre-drying step (80° C., 50 nm) and post-drying step (65° C., 90 nm)).

Results are given on FIG. 2A).

The rehydration speeds between two different strawberry based-products have been compared:
“strawberry freeze dried”: strawberry dices from the market
“strawberry NEW pieces”: strawberry dices of the invention (DIC process: 3 bars, 10 seconds, with pre-drying step (80° C., 50 nm) and post-drying step (65° C., 90 nm))

Results are given on FIG. 2B).

The rehydration speeds between two different mango based-products have been compared:
“mango freeze dried”: mango dices from the market
“mango New pieces”: mango dices of the invention (DIC process: 3 bars, 10 seconds, with pre-drying step (80° C., 50 nm) and post-drying step (65° C., 90 nm))

Results are given on FIG. 2C).

The rehydration speeds between two different carrot based-products have been compared:
“carrot air dried”: carrot dices from the market
“carrot New pieces”: carrot dices of the invention (cooking step: 36′ at 98° C., DIC process: 3 bars, 10 seconds, with pre-drying step (80° C., 50 nm) and post-drying step (65° C., 90 nm))

Results are given on FIG. 2D).

Surprisingly, the rehydration speed of the apple- and carrot-based products of the invention is higher during the first minutes of the experiment than those of the other tested products (see FIGS. 2A and D). It means that the rehydration of the apple and carrot products of the invention occurs faster, what appears to be a great advantage for obtaining the rehydrated products in less time.

For the strawberry and mango, the rehydration speed of freeze or air dried dices is too fast, conducting to a product with too soft texture. The parameters of the process of the present invention have been adapted in order to obtain fruit pieces having a slower speed of rehydration, thus leading to an optimal texture (see FIGS. 2B and C).

2.2. Texture

The springiness between four different apple based-products have been compared:
“Apple Air dried 1”: air-dried apple dices from the market,
“Apple Air dried 2”: apple dices dried with hot air (65° C., 5 hours)
“Apple DIC standard”: apple dices dried with a classical DIC process (3 bars, 20 seconds, 133.5° C., with pre-drying step (80° C., 55 nm) and post-drying step (65° C., 90 nm))
“Apple NEW pieces”: apple dices of the invention (DIC process: 2 bars, 20 seconds, with pre-drying step (80° C., 50 nm) and post-drying step (65° C., 90 nm)).

Results are given on FIG. 3A.

The springiness between four different carrot based-products have been compared:
“carrot Air dried”: air-dried apple dices from the market,
“carrot puffed”: carrot dices dried with an expansion step following pressure drop toward vacuum,
“carrot DIC standard”: carrot dices dried with a classical DIC process (3 bars, 20 seconds, 133.5° C., with pre-drying step (80° C., 55 nm) and post-drying step (65° C., 90 nm))
“carrot New pieces”: carrot dices of the invention (cooking step: 36′ at 98° C., DIC process: 2 bars, 20 seconds, with pre-drying step (80° C., 50 nm) and post-drying step (65° C., 90 nm)).

Results are given on FIG. 3B.

It has been measured that the rehydrated products of the invention have a springiness of between 30% and 40%, which corresponds to the ideal springiness for being easily chewed. The carrot and apple products have a significant lesser springiness than the products obtained with conventional air drying or the one currently available on the market (see FIGS. 3A and 3B), which are either too soft or too elastic or too hard to be easily chewed.

2.3. Bacteriology

The bacteriological results obtained on different pieces of the invention are presented in table 1:

TABLE 1

| | | | | | Coagulase | | |
|---|---|---|---|---|---|---|---|
| | Total plate | Entero- | | | positive | Listeria | |
| | count | bacteriaceae | Yeast | Mould | staphylococcus | monocytogenes | Salmonella |
| TARGET | <5000 | Absence in | <200 | <200 | <10 | Absence in | Absence |
| | | 1 gram | | | | 25 grams | in 25 |
| | | | | | | | grams |
| Apple | <100 | Absence | 100 | <10 | <10 | Absence | Absence |
| Carrot | 200 | Absence | 100 | <10 | <10 | Absence | Absence |
| Strawberry | <100 | Absence | 100 | <10 | <10 | Absence | Absence |
| Mango | <100 | Absence | 100 | <10 | <10 | Absence | Absence |

Conclusions:

The products obtained have a very low level of microbiological contamination and can therefore be safely used in clinical nutrition (including hospital food), baby food or senior food (microbial contaminants are destroyed during the fabrication process), providing attractive solutions to the market in the field of these foods.

2.4 Shelf-Life Stability

a) Sticking Ability

The tests highlighted that the dehydrated fruit dices or pieces of the invention were not agglomerated until 9 months when stored between 0-4° C. and 20° C. Therefore, no anti-sticking agent is required in case the product will be stored in these conditions.

However, when stored at 30° C., the dehydrated fruit dices or pieces of the invention begin to agglomerate after 1 month of storage, thus requiring the use of an anti-sticking agent.

With the help of an anti-sticking agent such as MCT or vegetal oil, the dehydrated fruit dices or pieces of the invention were still stable and not agglomerated after 9 months.

b) Color Stability

Under storage of the dehydrated fruit dices or pieces of the invention at −18° C., 0/+4° C., 20° C. and 30° C. until 9 months, the evolution of their color was not significant. The dices or pieces color can thus be considered as stable during at least 9 months whatever the storage temperature is.

c) Oxidation Stability

The tests underline that it is better using an anti-oxidating agent and nitrogen so as to diminish the oxidation of the carrots. With the help of these two solutions, the carrot dices or pieces were stable after 9 months.

d) Texture

After 9 months of shelf life tests, it has been found that there is a softening of the product when the dry product is taken in consideration, but there is no difference of texture after rehydration in application.

1. A method for obtaining a dehydrated chewy and non-sticky dice or piece of fruit or vegetable, comprising:
a) Providing a dice or piece of fruit or vegetable,
b) Pre-drying said dice or piece of fruit or vegetable,
c) Dehydrating the pre-dried dice or piece of fruit or vegetable obtained in b) in an instant controlled pressure drop DIC reactor, and
d) Post-drying of said dehydrated dice or piece of fruit or vegetable, said dehydrated dice or piece having a springiness comprised from 30 to 40% once rehydrated with 50° C. hot water during one minute.

2. The method according to claim 1, wherein the dice or piece of fruit or vegetable is obtained by a method comprising:
i) Optionally, washing of said fruit or vegetable, so as to remove potential dust and sand,
ii) optical sorting of said fruit or vegetable, so as to remove damaged fruit or vegetable, wood, leaves and/or stones,
iii) Optionally, removal of peel, core, seeds, and stem of said fruit or vegetable, and
iv) dicing said fruit or vegetable.

3. The method according to claim 1, wherein the dice or piece has a size of from 3×3×3 mm to 15×15×15 mm.

4. The method according to claim 1, further comprising defrosting before b) pre-drying, when said dice or piece of fruit or vegetable is a frozen raw material.

5. The method according to claim 2, wherein i) to iii) and/or iv) have been performed before freezing of raw material that forms said dice or piece of fruit or vegetable.

6. The method according to claim 1, further comprising colouring optionally with a natural colouring foodstuff.

7. The method according to claim 6, wherein said natural colouring foodstuff is a fruit or vegetable juice concentrate optionally comprising a blackcurrant juice, a tomato juice, a carrot juice, a beetroot juice, a strawberry juice, and/or a redfruit juice.

8. The method according to claim 1, wherein the dice or piece of fruit or vegetable is dipped in or sprayed with an aqueous solution comprising an anti-sticking agent, an anti-oxidating or an anti-browning agent, and/or an agent impairing said dice or piece to get rancid.

9. The method according to claim 8, wherein said anti-sticking agent is medium chain triglycerides (MCT) or a vegetal oil or starch or pectin or citrus fibre or an emulgator based on lecithin.

10. The method according to claim 8, wherein said anti-oxidating agent is citric acid and/or ascorbic acid and/or lemon juice.

11. The method according to claim 8, wherein said agent impairing said dice or piece to get rancid is tocopherol and/or ascorbyl palmitate.

12. The method according to claim 1, further comprising cooking or blanching before the pre-drying e).

13. The method according to claim 12, wherein the cooking or blanching is performed at a temperature comprised from 80° C. to 130° C., lasts from 5 seconds 40 minutes.

14. The method according to claim 1, wherein pre-drying b) is performed at a temperature comprised from 30° C. 120° C., optionally from 30 minutes to 3 hours.

15. The method according to claim 1, wherein dehydrating c) comprises, in a DIC reactor:
i) A short-time heat treatment at a temperature from 100 to 170° C., a pressure of from 1 to 8 bars, during 5 seconds till 1 minute, ii) A rapid drop pressure toward vacuum, lasting less than 1 second, iii) Maintenance of the vacuum lasting less than 10 seconds,
iv) Re-pressurising the reactor up to the atmosphere pressure.

16. The method according to claim 1, wherein the content in bacteria in said dice or piece is less than 1000 u/g after the dehydrating c) and absence of Enterobacteriaceae in 1 g.

17. The method according to claim 1, wherein post-drying d) is performed in a hot air dryer, optionally at a temperature comprised from 50° C. to 100° C., or optionally from 10 minutes to 120 minutes.

18. The method according to claim 1, wherein moisture of said dice or piece is less than 5% after post-drying d).

19. The method according to claim 1, further comprising conditioning under modified atmosphere.

20. A method for obtaining a non-sticky chewy rehydrated dice or piece of fruit or vegetable comprising:
a) Providing a dice or piece of fruit or vegetable, b) Pre-drying said dice or piece of fruit or vegetable, c) Dehydrating the pre-dried dice or piece of fruit or vegetable obtained in b) in an instant controlled pressure drop (DIC) reactor,
d) Post-drying of said dehydrated dice or piece of fruit or vegetable,
e) Optionally, conditioning or packaging said dehydrated dice or piece obtained in d),
f) Rehydrating said dehydrated dice or piece obtained in d) or e),
said rehydrated dice or piece having a springiness comprised from 30 to 40%, once rehydrated in 50° C. water during 1 minute.

21. The method according to claim 20, wherein the rehydrating comprises adding hot liquid on the dehydrated dice or piece obtained in d) or e).

22. The method according to claim 21, wherein said liquid is milk or water.

23. The method according to claim 20, wherein said hot liquid is at a temperature of about 50° C.

24. The method according to claim 20, wherein said rehydrating lasts at least 30 seconds.

25. A dehydrated fruit or vegetable dice or piece obtainable by the method of claim 1, having a springiness comprised from 30 to 40% once rehydrated with 50° C. hot water during 1 minute.

26. The rehydrated fruit or vegetable dice or piece obtainable by the method of claim 20, having a springiness comprised from 30 to 40% once rehydrated in 50° C. water during 1 minute.

27. The dehydrated fruit or vegetable dice or piece of claim 25, capable of being used in a senior food.

28. The dehydrated fruit or vegetable dice or piece of claim 25, capable of being used in clinical nutrition including hospital food.

29. The dehydrated fruit or vegetable dice or piece of claim 25, capable of being used in a sweet food or dried savoury food product.
